(19) United States
(12) Patent Application Publication
(10) Pub. No.: US 2017/0256361 A1
(43) Pub. Date: Sep. 7, 2017

(54) FILM CAPACITOR

(71) Applicant: BYD COMPANY LIMITED, Shenzhen (CN)

(72) Inventors: WEI YANG, SHENZHEN (CN); PENGCHENG YANG, SHENZHEN (CN); SIYUAN LIU, SHENZHEN (CN)

(21) Appl. No.: 15/603,144

(22) Filed: May 23, 2017

Related U.S. Application Data
(63) Continuation of application No. PCT/CN2015/095340, filed on Nov. 23, 2015.

(30) Foreign Application Priority Data
Nov. 28, 2014 (CN) 201410709240.9

(51) Int. Cl. H01G 4/33; H01G 4/224; H02G 5/00; H01G 4/228

(52) U.S. Cl. CPC H01G 4/33; H01G 4/228; H01G 4/224; H02G 5/00

(57) ABSTRACT

The present disclosure discloses a film capacitor, including: a plurality of capacitor cores; a positive electrode busbar, disposed on a side surface of each of the plurality of capacitor cores; a negative electrode busbar, superposed on the positive electrode busbar and insulated from the positive electrode busbar; a plurality of first connection sheets, each of the plurality of first connection sheets being connected to the positive electrode busbar and a positive electrode of each of the plurality of capacitor cores; and a plurality of second connection sheets, each of the plurality of second connection sheets being connected to the negative electrode busbar and a negative electrode of each of the plurality of capacitor cores, wherein the plurality of first connection sheets and the plurality of second connection sheets disposed on a same side of the plurality of capacitor cores are alternately arranged.

### CROSS-REFERENCE TO RELATED APPLICATIONS

This application is a continuation application of International Application No. PCT/CN2015/095340, filed on Nov. 23, 2015, which is based on and claims priority to and benefits of Chinese Patent Application No. 201410709240.9, filed with the State Intellectual Property Office (SIPO) of the People's Republic of China on Nov. 28, 2014. The entire contents of the above-identified application are incorporated herein by reference.

### FIELD

The present disclosure relates to a capacitor, and more particularly relates to a film capacitor.

### BACKGROUND

A film capacitor such as a metalized film capacitor has characteristics like a low loss, a high voltage resistance, a temperature characteristic and a good frequency characteristic.

Chinese patent CN1714415B discloses a metalized film capacitor. Two buses of the metallized film capacitor are connected to a capacitor core and oppositely disposed at both sides of the capacitor core. Chinese patent CN202384178U discloses a capacitor structure having an internal laminated busbar. The first and second busbars of the capacitor structure have L shapes and bottoms of the first and second busbars are superposed with each other. Side walls of the two busbars are opposite to each other and provided with welding portions, and the welding portions are welded with the capacitor core. In the capacitor described above, since the busbars are disposed on both sides of the capacitor core respectively and opposed to each other, many problems may appear, for example, inconvenience of an arrangement of the busbars and disadvantage on heat dissipation of the busbars. In addition, the capacitor still has other problems to be solved, such as a large inductance and an uneven current.

### SUMMARY

The present disclosure aims to solve at least one of the above problems.

Accordingly, the present disclosure provides a film capacitor, which has a low inductance, an uniform current and good performance.

The film capacitor according to embodiments of the present disclosure includes: a plurality of capacitor cores, a positive electrode busbar, disposed on a side surface of each capacitor core, a negative electrode busbar, superposed on the positive electrode busbar and insulated from the positive electrode busbar, a plurality of first connection sheets, each first connection sheet being connected to the positive electrode busbar and a positive electrode of each capacitor core, and a plurality of second connection sheets, each second connection sheet being connected to the negative electrode busbar and a negative electrode of each capacitor core, wherein the plurality of first connection sheets and the plurality of second connection sheets disposed on a same side of the plurality of capacitor cores are substantially alternately arranged.

In some embodiments, the film capacitor further includes: a first electrode terminal connected to the positive electrode busbar, and a second electrode terminal connected to the negative electrode busbar.

In some embodiments, the film capacitor further includes a casing, wherein the plurality of capacitor cores, the positive electrode busbar, the negative electrode busbar, the plurality of first connection sheets and the plurality of second connection sheets are disposed within the casing and sealed by potting insulators.

In some embodiments, the film capacitor further includes an insulation sheet located between the positive electrode busbar and the negative electrode busbar.

In some embodiments, the positive electrode busbar is attached to an upper surface of each capacitor core.

In some embodiments, each first connection sheet is integrally formed with the positive electrode busbar, and bent to the positive electrode of each capacitor core, and each second connection sheet is integrally formed with the negative electrode busbar, and bent to the negative electrode of each capacitor core.

In some embodiments, each first connection sheet is provided with a first connection terminal connected to each capacitor core, and each second connection sheet is provided with a second connection terminal connected to each capacitor core.

In some embodiments, a plurality of the first connection terminals is provided, disposed at a peripheral edge of the first connection sheet and spaced apart from each other, and a plurality the second connection terminals is provided, disposed at a peripheral edge of the second connection sheet and spaced apart from each other.

In some embodiments, the plurality of the first connection terminals and the plurality of the second connection terminals are provided to form a plurality of pairs of connection terminals.

In some embodiments, the first connection terminal and the first connection sheet are integrally formed, and the second connection terminal and the second connection sheet are integrally formed.

In some embodiments, the plurality of capacitor cores is arranged in a plurality of columns and layers, and the positive electrode busbar is disposed on a top layer of the capacitor cores.

In some embodiments, the plurality of capacitor cores is arranged in an even number of the columns, and the first connection sheets and the second connection sheets disposed on the same side of the plurality of capacitor cores are alternately arranged.

In some embodiments, the plurality of capacitor cores is arranged in an odd number of the columns, and the first connection sheets and the second connection sheets disposed on the same side of the plurality of capacitor cores are alternately arranged, apart from the first connection sheet or the second connection sheet disposed on the same side of one of the plurality of capacitor cores.

With the film capacitor according to embodiments of the present disclosure, by providing a structure in which the first connection sheet and the second connection sheet disposed on the same side of the plurality of capacitor cores are alternately arranged, i.e. at both sides of the plurality of capacitor cores, the first connection sheet and the second connection sheet are respectively alternately provided, current directions of adjacent two capacitor cores are different, which may make inductances of adjacent two capacitor cores counteract with each other, thus the self-inductance of the film capacitor according to the present disclosure may be reduced, and the current flowing through any position of the interior of the film capacitor may be more uniform, thus providing a much better whole performance of the film capacitor.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic view of a film capacitor according to an embodiment of the present disclosure;

FIG. 2 is a schematic view of a positive electrode busbar and a negative electrode busbar of a film capacitor according to an embodiment of the present disclosure as shown in FIG. 1;

FIG. 3 is a front view of a film capacitor according to an embodiment of the present disclosure as shown in FIG. 1;

FIG. 4 is a top view of a film capacitor according to an embodiment of the present disclosure as shown in FIG. 1;

FIG. 5 is a side view of a film capacitor according to an embodiment of the present disclosure as shown in FIG. 1;

FIG. 6 is a schematic view of a film capacitor according to another embodiment of the present disclosure;

FIG. 7 is a schematic view of a positive electrode busbar and a negative electrode busbar of a film capacitor according to an embodiment of the present disclosure as shown in FIG. 6;

FIG. 8 is a front view of a film capacitor according to an embodiment of the present disclosure as shown in FIG. 6;

FIG. 9 is a top view of a film capacitor according to an embodiment of the present disclosure as shown in FIG. 6; and

FIG. 10 is a side view of a film capacitor according to an embodiment of the present disclosure as shown in FIG. 6.

### REFERENCE NUMERALS

film capacitor 100;

positive electrode busbar 20; first electrode terminal 21; first connection sheet 22; first connection terminal 221;

negative electrode busbar 30; second electrode terminal 31; second connection sheet 32; second connection terminal 321;

insulation sheet 40; capacitor core 50.

### DETAILED DESCRIPTION

Reference will be made in detail to embodiments of the present disclosure, where the same or similar elements and the elements having the same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, it is to be understood that terms such as “length,” “width,” “thickness,” “upper,” “lower,” “front,” “rear,” “left,” “right,” “vertical,” “horizontal,” “top,” “bottom,” “inner,” and “outer” should be construed to refer to the orientation as then described or as shown in the drawings under discussion. These relative terms are for convenience of description and do not require that the present disclosure be constructed or operated in a particular orientation, thus shall not be construed to limit the present disclosure. In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, “a plurality of” means at least two, e.g. two, three and so on, unless specified otherwise.

In the description of the present disclosure, it should be understood that, unless specified or limited otherwise, the terms “mounted,” “supported,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

A film capacitor 100 according to embodiments of the present disclosure will be described with reference to drawings.

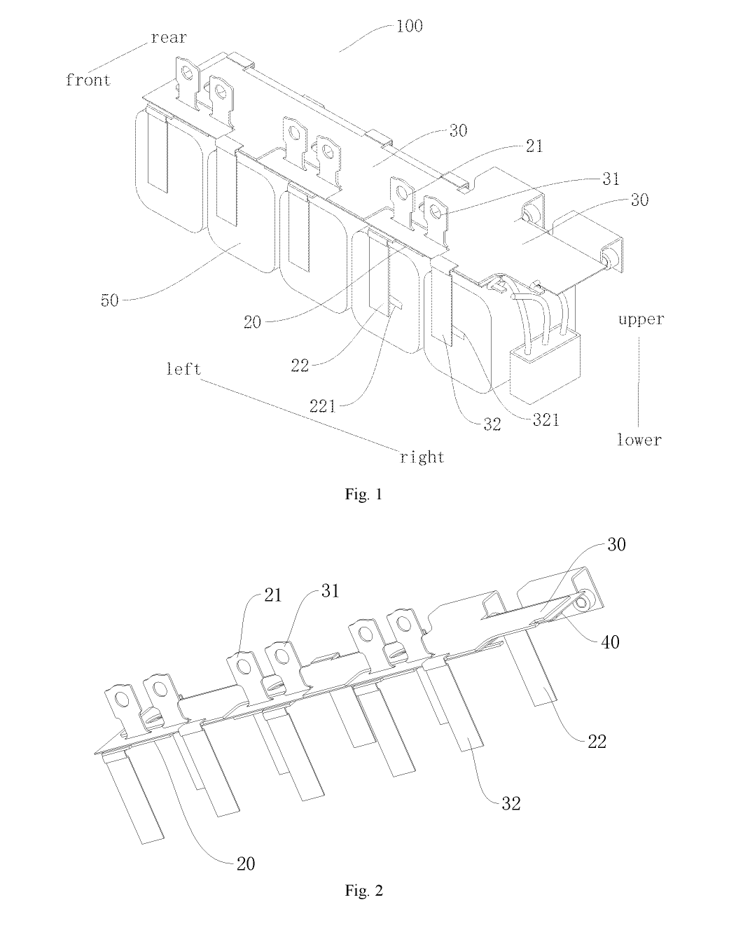

As shown in FIGS. 1 to 10, the film capacitor 100 according to embodiments of the present disclosure includes: a casing, a plurality of capacitor cores 50, a positive electrode busbar 20, a negative electrode busbar 30, a plurality of first connection sheets 22 each connected to the positive electrode busbar 20, a plurality of second connection sheets 32 each connected to the negative electrode busbar 30, a first electrode terminal 21 connected to the positive electrode busbar 20 and a second electrode terminal 31 connected to the negative electrode busbar 30.

Specifically, the plurality of capacitor cores 50, the positive electrode busbar 20, the negative electrode busbar 30, the plurality of first connection sheets 22, and the plurality of second connection sheets 32 are disposed within the casing and sealed by potting insulators. The positive electrode busbar 20 and the negative electrode busbar 30 are superposed with each other, further, the negative electrode busbar 30 is superposed on the positive electrode busbar 20, and an insulation sheet 40 is provided between the positive electrode busbar 20 and the negative electrode busbar 30. The positive electrode busbar 20 is disposed on a side surface of the capacitor core 50, preferably, on an upper surface of the capacitor core 50. The first connection sheet 22 is connected to a positive electrode of the capacitor core 50, the second connection sheet 32 is connected to a negative electrode of the capacitor core 50, the first connection sheet 22 and the second connection sheet 32 disposed on a same side of the plurality of capacitor cores 50 are alternately arranged.

In other words, the negative electrode busbar 30, the insulation sheet 40 and the positive electrode busbar 20 are superposed together in an upper and lower direction, i.e., the negative electrode busbar 30, the insulation sheet 40 and the positive electrode busbar 20 are superposed together in turn from top to bottom, and the insulation sheet 40 is provided between the positive electrode busbar 20 and the negative electrode busbar 30 to make the positive electrode busbar 20 and the negative electrode busbar 30 insulated from each other. The plurality of capacitor cores 50 is provided in a length direction of the positive electrode busbar 20, also in a length direction of the negative electrode busbar 30. A plurality of the first connection sheets 22 and a plurality of the second connection sheets 32 are also provided in the length direction of the positive electrode busbar 20, also in the length direction of the negative electrode busbar 30.

The first connection sheet 22 may be perpendicularly connected to a front or rear edge of the positive electrode busbar 20, and the second connection sheet 32 may be perpendicularly connected to a front or rear edge of the negative electrode busbar 30. At a front side of the capacitor core 50, the plurality of the first connection sheets 22 and the plurality of the second connection sheets 32 are provided, and the plurality of the first connection sheets 22 and the plurality of the second connection sheets are alternately arranged. Adjacent two of the capacitor cores 50 in the length direction of the positive electrode busbar 20 (i.e., in the length direction of the negative electrode busbar 30) are respectively connected to the first connection sheet 22 and the second connection sheet 32.

Therefore, with the film capacitor 100 according to embodiments of the present disclosure, the first connection sheet 22 and the second connection sheet 32 may be directly connected to the capacitor core 50 in a welding manner, which is convenient for the welding automation, effectively improves the product quality and the manufacturing efficiency and reduces the cost. The negative electrode busbar 30, the positive electrode busbar 20 and the insulation sheet 40 are superposed on the side surface of the capacitor core 50, i.e. the upper surface of the capacitor core 50, and thus a distance away from a leading-out terminal of an Insulated Gate Bipolar Translator (IGBT) is much shorter, and an inductance corresponding thereto is much lower. Designs of the positive electrode busbar 20 and the negative electrode busbar 30 are very simple, in addition, since the superposed region thereof may be not pressed, a connection between the positive electrode and the negative electrode may be not caused, thus save manufacturing costs.

In addition, by providing a structure in which the first connection sheet 22 and the second connection sheet 32 disposed on the same side of the capacitor core 50 are alternately arranged, i.e. at both sides of the capacitor core 50, the first connection sheet 22 and the second connection sheet 33 are respectively alternately provided, and current directions of adjacent two capacitor cores 50 are different, which may make inductances of adjacent two capacitor cores 50 counteract with each other, thus the self-inductance of the film capacitor 100 according to the present disclosure may be reduced, and the current flowing through any position of the interior of the film capacitor 100 may be more uniform, thus providing a much better whole performance of the film capacitor 100.

In one embodiment according to the present disclosure, the positive electrode busbar 20 is attached to the upper surface of the capacitor core 50. In other words, the positive electrode busbar 20 has a lower surface thereof directly touching the upper surface of the capacitor core 50. With a foregoing structure, the distance between the capacitor core 50 and the leading-out terminal of an IGBT may be further reduced, and the inductance may be further reduced accordingly.

In some embodiments according to the present disclosure, the first connection sheet 22 is integrally formed with the positive electrode busbar 20, and bent to the positive electrode of the capacitor core 50. Furthermore, the second connection sheet 32 is integrally formed with the negative electrode busbar 30, and bent to the negative electrode of the capacitor core 50.

As shown in FIGS. 2 and 7, the first connection sheet 22 is a portion of the positive electrode busbar 20, extended downwards from the front or rear edge of the positive electrode busbar 20 and perpendicular to the positive electrode busbar 20 so as to be attached to the positive electrode of the capacitor core 50, i.e., to a front or rear end surface of the capacitor core 50. The second connection sheet 32 is a portion of the negative electrode busbar 30, extended downwards from an front or rear edge of the negative electrode busbar 30 and perpendicular to the negative electrode busbar 30 so as to attached to the negative electrode of the capacitor core 50, i.e., to the front or rear end surface of the capacitor core 50. Thus, the film capacitor 100 is further simplified, and is easier to be formed and assembled, which further reduces the manufacturing cost.

According to an embodiment of the present disclosure, the first connection sheet 22 is provided with a first connection terminal 221 connected to the capacitor core 50, and the second connection sheet 32 is provided with a second connection terminal 321 connected to the capacitor core 50. In some embodiments, a plurality of the first connection terminals 221 is provided, disposed at a peripheral edge of the first connection sheet 22 and spaced apart from each other; a plurality of the second connection terminals 321 is provided, disposed at a peripheral edge of the second connection sheet 32 and spaced apart from each other.

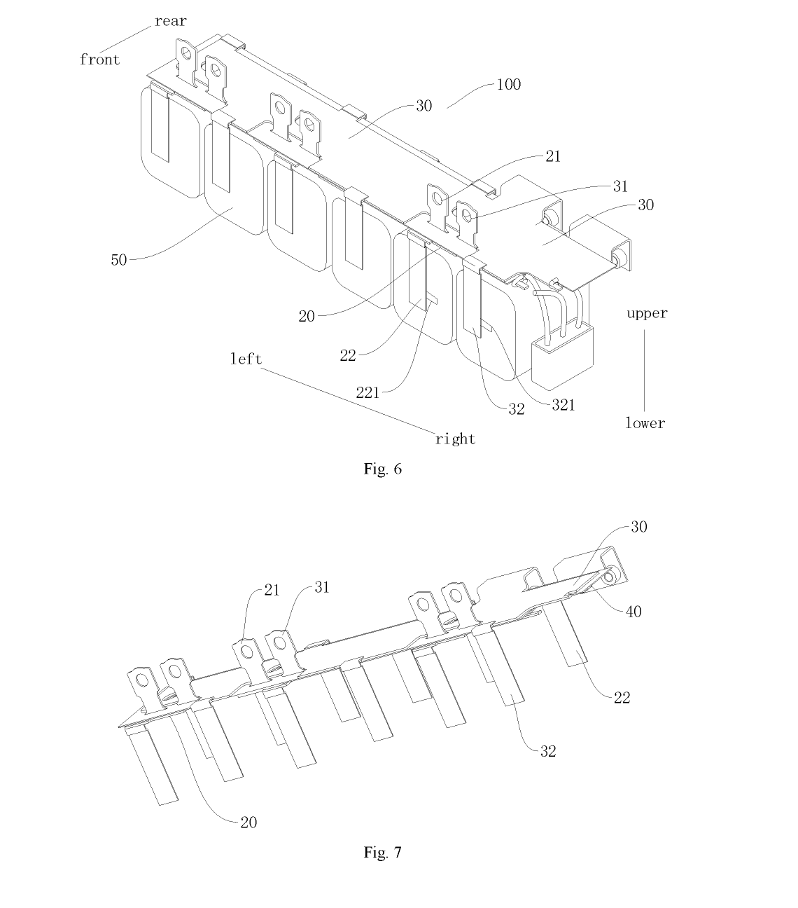

Specifically, as shown in FIGS. 1 and 6, in some embodiments according to the present disclosure, the plurality of the first connection terminals 221 and the plurality of the second connection terminals 321 are provided to form a plurality of pairs of connection terminals, and the first connection terminal 221 is opposite to the second connection terminal 321 in each pair. In other words, the plurality of the first connection terminals 221 is disposed at the peripheral edge of the first connection sheet 22 and connected to the positive electrode of the capacitor core 50, i.e., to the front or rear end surface of the capacitor core 50. The plurality of the second connection terminals 321 is disposed at the peripheral edge of the second connection sheet 32 and connected to the negative electrode of the capacitor core 50, i.e., to the front or rear end surface of the capacitor core 50.

In one embodiment according to the present disclosure, the first connection terminal 221 and the first connection sheet 22 are integrally formed, and the second connection terminal 321 and the second connection sheet 32 are integrally formed. Thus, the film capacitor 100 having this structure presents higher structural stability and is easier to form and assemble, which further reduces the manufacturing cost.

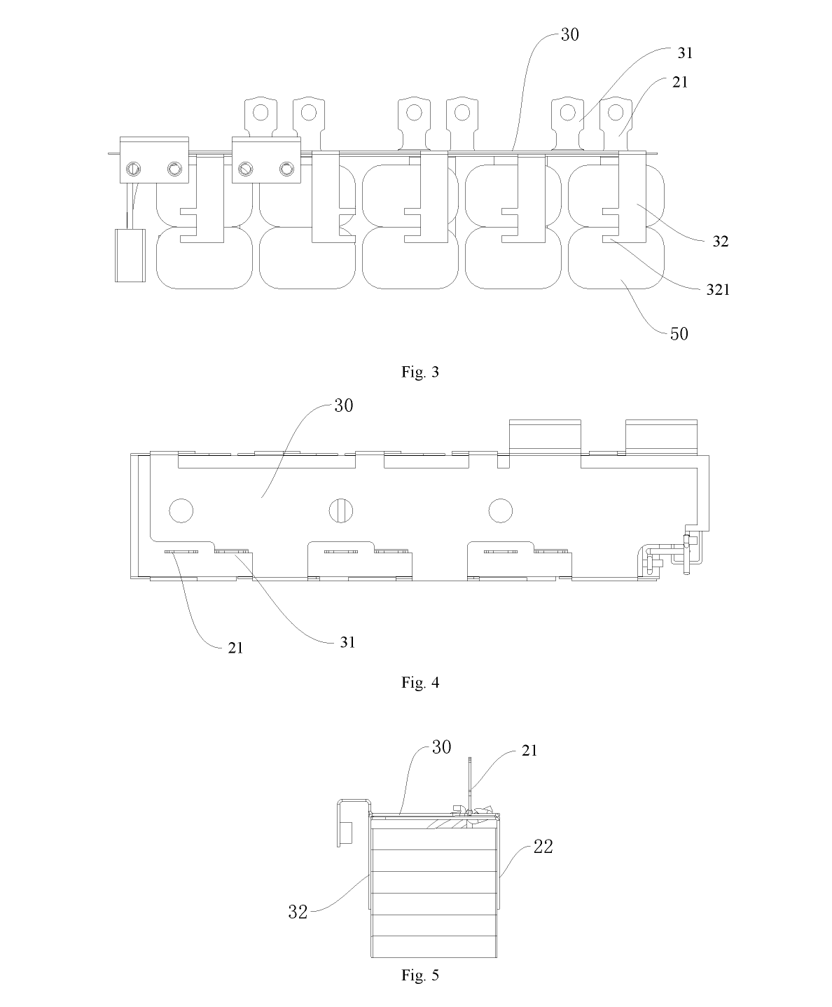

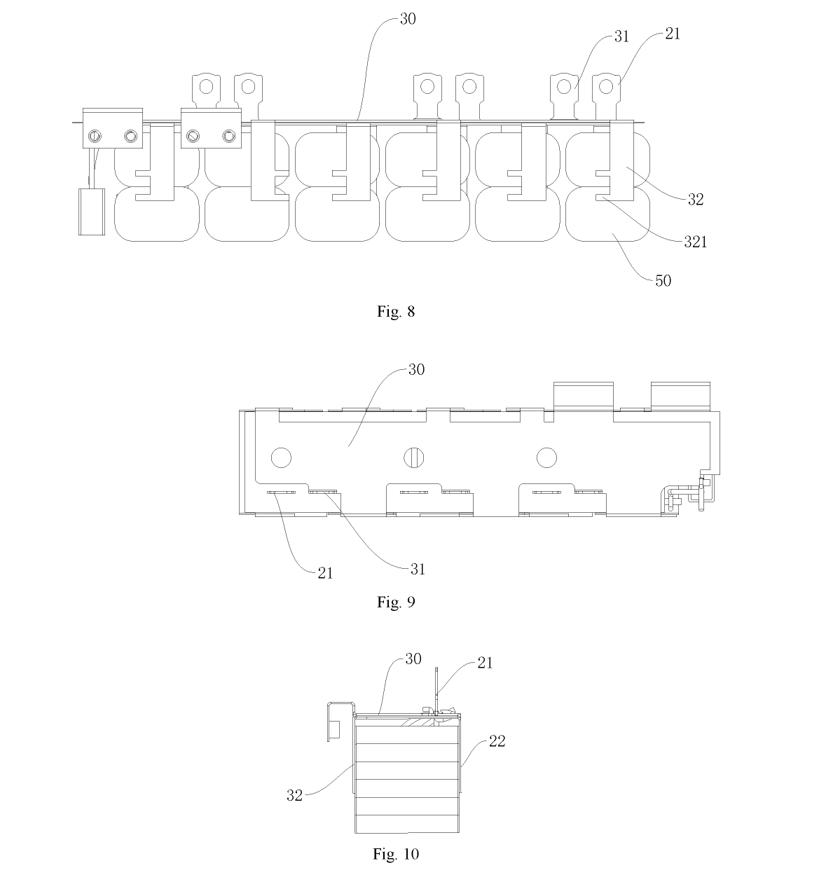

In some embodiments according to the present disclosure, as shown in FIGS. 3 and 8, the plurality of capacitor cores 50 is arranged in a plurality of columns and layers. The positive electrode busbar 20 is disposed on a top layer of the capacitor cores 50. With the foregoing structure, the plurality of capacitor cores 50 may be assembled within the film capacitor 100, and there is no need to perform a press-fit treatment on the superposed region of the positive electrode busbar 20 and the negative electrode busbar 30, thus saving manufacturing costs.

In an embodiment of the present disclosure as shown in FIGS. 3 and 8, each of numbers of the first connection terminals 221 and the second connection terminals 321 may be corresponding to a number of the layers in which the capacitor cores 50 are arranged. Arrangement positions of the first connection terminals 221 on the first connection sheet 22 may be the same with those of the second connection terminals 321 on the second connection sheet 32, so that both end surfaces of each capacitor core 50 can be connected to the corresponding first connection terminal 221 and second connection terminal 321, respectively.

Considering that a number of the plurality of capacitor cores 50 in each column may be even or odd, different arrangements of the first connection sheet 22 and the second connection sheet 32 may be provided.

For example, as shown in FIGS. 6-10, when the plurality of the capacitor cores 50 is arranged in an even number of the columns, i.e. the number of the capacitor cores 50 in each layer in the length direction of the positive electrode busbar 20 (or, in the length direction of the negative electrode busbar 30) is even, the first connection sheet 22 and the second connection sheet 32 disposed on the same side of the plurality of the capacitor cores 50 are alternately arranged. That means, when the number of the capacitor cores 50 in each layer in the length direction of the positive electrode busbar 20 (or, in the length direction of the negative electrode busbar 30) is even, the inductances of any adjacent two capacitor cores 50 may counteract with each other, thus more effectively reducing the self-inductance of the film capacitor 100.

As shown in FIGS. 1-5, when the plurality of the capacitor cores 50 is arranged in an odd number of the columns, i.e. the number of the capacitor cores 50 in each layer in the length direction of the positive electrode busbar 20 (or, in the length direction of the negative electrode busbar 30) is odd, the first connection sheet 22 and the second connection sheet 32 disposed on the same side of the plurality of capacitor cores 50 are alternately arranged, apart from the first connection sheet 22 or the second connection sheet 32 disposed on the same side of one of the plurality of capacitor cores 50. That is, the one of the plurality of the capacitor cores 50 may be is arranged at a certain position, and the first connection sheet 22 and the second connection sheet 32 disposed on the same side of the rest of the plurality of the capacitor cores 50 are alternately arranged. That means, with the exception of the one of the plurality of capacitor cores 50, the inductances of any adjacent two of the rest of the plurality of the capacitor cores 50 may counteract with each other, thus more effectively reducing the self-inductance of the film capacitor 100. Herein, the one of the plurality of capacitor cores 50 may be disposed at any position. Specifically, the rest of the plurality of capacitor cores 50 serve as an entity, the one of the plurality of capacitor cores 50 may be disposed at a left or right end of the entity or at any position in the entity, without special limitation.

Other structures and operations of the film capacitor 100 according to embodiments of the present disclosure are known to those skilled in the related art, and thus will not be described in detail here.

Reference throughout this specification to “one embodiment”, “some embodiments,” “an embodiment”, “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. A film capacitor, comprising:
a plurality of capacitor cores;
a positive electrode busbar, disposed on a side surface of each of the plurality of capacitor cores;
a negative electrode busbar, superposed on the positive electrode busbar and insulated from the positive electrode busbar;
a plurality of first connection sheets, each of the plurality of first connection sheets being connected to the positive electrode busbar and a positive electrode of each of the plurality of capacitor cores; and
a plurality of second connection sheets, each of the plurality of second connection sheets being connected to the negative electrode busbar and a negative electrode of each of the plurality of capacitor cores,
wherein the plurality of first connection sheets and the plurality of second connection sheets disposed on a same side of the plurality of capacitor cores are alternately arranged.

2. The film capacitor according to claim 1, further comprising:
a first electrode terminal connected to the positive electrode busbar; and
a second electrode terminal connected to the negative electrode busbar.

3. The film capacitor according to claim 1, further comprising a casing,
wherein the plurality of capacitor cores, the positive electrode busbar, the negative electrode busbar, the plurality of first connection sheets and the plurality of second connection sheets are disposed within the casing and sealed by potting insulators.

4. The film capacitor according to claim 1, further comprising an insulation sheet located between the positive electrode busbar and the negative electrode busbar.

5. The film capacitor according to claim 1, wherein the positive electrode busbar is attached to an upper surface of each of the plurality of capacitor cores.

6. The film capacitor according to claim 1, wherein each of the plurality of first connection sheets is integrally formed with the positive electrode busbar and bent to the positive electrode of each of the plurality of capacitor cores; and
each of the plurality of second connection sheets is integrally formed with the negative electrode busbar and bent to the negative electrode of each of the plurality of capacitor cores.

7. The film capacitor according to claim 1, wherein each of the plurality of first connection sheets is provided with a first connection terminal connected to each of the plurality of capacitor cores; and
each of the plurality of second connection sheets is provided with a second connection terminal connected to each of the plurality of capacitor cores.

8. The film capacitor according to claim 7, wherein a plurality of the first connection terminals is provided, disposed at a peripheral edge of the first connection sheet and spaced apart from each other, and a plurality the second connection terminals is provided, disposed at a peripheral edge of the second connection sheet and spaced apart from each other.

9. The film capacitor according to claim 8, wherein the plurality of the first connection terminals and the plurality of the second connection terminals are provided to form a plurality of pairs of connection terminals.

10. The film capacitor according to claim 7, wherein the first connection terminal and the first connection sheet are integrally formed, and the second connection terminal and the second connection sheet are integrally formed.

11. The film capacitor according to claim 1, wherein the plurality of capacitor cores is arranged in a plurality of columns and layers, and the positive electrode busbar is disposed on a top layer of the capacitor cores.

12. The film capacitor according to claim 11, wherein the plurality of capacitor cores is arranged in an even number of the columns, and the first connection sheets and the second connection sheets disposed on the same side of the plurality of capacitor cores are alternately arranged.

13. The film capacitor according to claim 11, wherein the plurality of capacitor cores is arranged in an odd number of the columns, and the first connection sheets and the second connection sheets disposed on the same side of the plurality of capacitor cores are alternately arranged, apart from the first connection sheet or the second connection sheet disposed on the same side of one of the plurality of capacitor cores.

14. A film capacitor, comprising:
a plurality of capacitor cores;
a positive electrode busbar;
a negative electrode busbar;
a plurality of first connection sheets, each of the plurality of first connection sheets being connected to the positive electrode busbar and a positive electrode of each of the plurality of capacitor cores; and
a plurality of second connection sheets, each of the plurality of second connection sheets being connected to the negative electrode busbar and a negative electrode of each of the plurality of capacitor cores,
wherein the plurality of first connection sheets and the plurality of second connection sheets disposed on a same side of the plurality of capacitor cores are alternately arranged.

15. The film capacitor according to claim 14, further comprising:
a first electrode terminal connected to the positive electrode busbar; and
a second electrode terminal connected to the negative electrode busbar.

16. The film capacitor according to claim 14, further comprising a casing,
wherein the plurality of capacitor cores, the positive electrode busbar, the negative electrode busbar, the plurality of first connection sheets and the plurality of second connection sheets are disposed within the casing and sealed by potting insulators.

17. The film capacitor according to claim 14, further comprising an insulation sheet located between the positive electrode busbar and the negative electrode busbar.

18. The film capacitor according to claim 14, wherein the positive electrode busbar is attached to an upper surface of each of the plurality of capacitor cores, and the negative electrode busbar is superposed on the positive electrode busbar and insulated from the positive electrode busbar.

19. The film capacitor according to claim 14, wherein each of the plurality of first connection sheets is provided with a first connection terminal connected to each of the plurality of capacitor cores; and
each of the plurality of second connection sheets is provided with a second connection terminal connected to each of the capacitor cores.

20. The film capacitor according to claim 14, wherein the plurality of capacitor cores is arranged in a plurality of columns and layers, and the positive electrode busbar is disposed on a top layer of the capacitor cores.
